(19) United States
(12) Patent Application Publication
(10) Pub. No.: US 2011/0125362 A1
(43) Pub. Date: May 26, 2011

(54) OPERATION SUPPORT APPARATUS AND OPERATION SUPPORT METHOD

(75) Inventor: Masaki Matsunaga, Kanagawa-ken (JP)

(73) Assignee: TOYOTA JIDOSHA KABUSHIKI KAISHA, Toyota-shi, Aichi-ken (JP)

(21) Appl. No.: 13/054,635

(22) PCT Filed: Jul. 16, 2009
(86) PCT No.: PCT/IB09/06244

§ 371 Date: Jan. 18, 2011

(30) Foreign Application Priority Data
Jul. 17, 2008 (JP) 2008-186438

(51) Int. Cl. G06F 7/00; B60W 10/18; B60W 10/20

(52) U.S. Cl. 701/29

(57) ABSTRACT

An operation support apparatus includes: a musculoskeletal status detection unit that detects a musculoskeletal status of an operator; an operating member operated by the operator; an activating mechanism that is operated in response to an operation of the operating member; and a control unit including: a musculoskeletal status information acquisition unit that acquires musculoskeletal status information of the operator by controlling the musculoskeletal status detection unit; an operation prediction unit that predicts whether operation of the operating member is operated by the operator based on the musculoskeletal status information acquired by the musculoskeletal status information acquisition unit; and a mechanism control unit that either executes a preprocessing operation of actual operation of the activating mechanism prior to operation of the operating member, or initiates the actual operation, in a case where operation of the operating member has been predicted to be operated by the operation prediction unit.

### BACKGROUND OF THE INVENTION

1. Field of the Invention

The invention relates to an operation support-apparatus and an operation support method.

2. Description of the Related Art

Technologies exist for sensing the status of an operator and controlling various types of activating mechanisms based on that status, and with respect to vehicle control, attempts to alter vehicle control by monitoring the inputs and results of driving operations by a driver of a vehicle or the cognitive status of a vehicle driver have been reported.

For example, a driving position adjustment apparatus described in Japanese Patent Application Publication No. 2006-123640 (JP-A-2006-123640) detects a joint bending angle of a driver from image information captured with a camera, calculates the optimum amount of movement of a seat and steering wheel based on that joint bending angle, and adjusts the seat and steering wheel based on the calculated amount of movement so that the positions of the seat, steering wheel and driver are at the ideal driving positions.

In addition, a variable steering angle steering apparatus described in Japanese Patent Application Publication No. 2007-168641 (JP-A-2007-168641) is an example of vehicle stability control (VSC) that controls vehicle motion by estimating target vehicle status quantities (such as vehicle speed, yaw rate or horizontal acceleration) for steering input angle, and more specifically, automatically controls steering angle that conforms to an intention of avoidance of a driver when an emergency avoidance operation has been carried out by a driver by detecting an emergency avoidance operation by a driver based on vehicle speed and steering wheel steering status and controlling steering output corresponding to that emergency avoidance operation.

On the other hand, there are also technologies for predicting human behavior.

For example, a muscle activity estimation system described in Japanese Patent Application Publication No. 2006-110217 (JP-A-2006-110217) estimates muscle activity status of a human being from the respective motion status quantities of joints and muscles of a human being operating a certain target object and the rigidity and viscosity of a target object to be operated.

Here, it is typically desirable to initiate a driving support apparatus as quickly as possible (rapid initiation) in order to ensure the safety of a vehicle driver during vehicle control.

Therefore, a technology can be considered for emitting a “vehicle driver facial orientation alarm” that detects the orientation of a driver's face by utilizing JP-A-2006-123640 and the like for detecting the status of a driver from image information captured with a camera, or in other words, a technology for accelerating the timing of pre-crash safety system (PCS) alarms in the case a driver has shifted his or her line of sight to a direction different from a direction of travel and the like by monitoring the orientation of the driver's face with a camera.

However, in the case of the “vehicle driver facial orientation alarm” utilizing JP-A-2006-123640, since cognitive behavior of a driver is estimated by monitoring a driver's face orientation and line of sight based only on image information captured with a camera, since there are numerous uncertain elements present leading up to actual operation by the driver, although this approach may be suitable for estimating the cognitive status of a driver (such as awareness or unawareness), it has the problem of being unsuitable for predicting operations by the driver.

In addition, the VSC in steering cooperative mode described in JP-A-2007-168641 carries out control based on information relating to operations previously carried out by a driver. Namely, although this type of control is superior in terms of being essentially free of uncertain elements (namely, does not have any predicted elements) since control is carried out based on previous results without predicting future operations, since operation of vehicle motion control is initiated based on operations that have already been carried out by the driver, it has the problem of inevitably containing a “delay element”. In the case of VSC in steering cooperative mode, for example, as a result of unavoidably containing this “delay element”, there is the possibility of the occurrence of a divergent state between an operation by the driver and a vehicle control operation, thereby resulting in the problem of this type of control having incomplete aspects such as the occurrence of situations unable to be handled by vehicle control.

In this manner, although the facial orientation of a vehicle driver or an emergency avoidance operation is detected in the related art described in JP-A-2006-123640 and JP-A-2007-168641, since these are not predicted in advance, even if a driving support apparatus is rapidly initiated in order to ensure safety, in the case of a situation in which an emergency avoidance operation is not actually required, there is the problem of the driving support apparatus ending up not being required as a result of rapid initiation thereof. In addition, it is also necessary to estimate what type of driving support is desired by a driver with a high degree of accuracy, and in the case the contents of driving support desired by a vehicle driver cannot be estimated with high accuracy, there is the problem of being unable to provide the driver with comfortable driving support. In addition, since control is initiated based on information relating to operations carried out by a vehicle driver, there is the problem of the control not being initiated rapidly, thereby causing the timing of control initiation to inevitably contain a “delay element”.

In order to solve the above-mentioned problems, it is necessary to initiate (including rapid initiation) a driving support apparatus at the appropriate timing after having accurately predicted actual motions and operations of a driver and status directly related to those operations. In addition, although it is desirable to remove the above-mentioned “delay element” as much as possible in order to more safely carry out vehicle motion control, since there are cases in which operation becomes unnecessary if control is initiated more rapidly (rapid initiation), it is necessary to accurately predict whether or not initiation of control is desirable with respect to rapid initiation.

Therefore, although use of technology such as that described in JP-A-2006-110217 for predicting human behavior may be considered, since the prediction technology of JP-A-2006-110217 is only able to estimate the behavior of a vehicle driver in a situation such as colliding with an obstacle using a computer graphics model by estimating muscle activity status of a driver operating a vehicle from the respective motion status quantities of joints and muscles of the driver and the rigidity and viscosity of the vehicle being operated, this technology has the problem of not enabling actual vehicle control based on these estimation results.

### SUMMARY OF THE INVENTION

An object of the invention is to provide an operation support apparatus, capable of accurately monitoring and estimating the cognizance and operation (including vehicle motion) of an operator during activating mechanism control (including vehicle motion control), and realizing safer and more comfortable operation of activating mechanisms (including vehicle motion) based on those estimate results, and an operation support method.

In one aspect of the invention, the operation support apparatus has a musculoskeletal status detection unit for detecting a musculoskeletal status of an operator; an operating member operated by the operator; an activating mechanism that operates in response to an operation of the operating member; and a control unit. The control unit includes a musculoskeletal status information acquisition unit for acquiring musculoskeletal status information of the operator by controlling the musculoskeletal status detection unit, an operation prediction unit for predicting whether the operation of the operating member is operated by the operator based on the musculoskeletal status information acquired by the musculoskeletal status information acquisition unit, and a mechanism control unit that either executes a preprocessing operation of an actual operation of the activating mechanism prior to the operation of the operating member, or initiates the actual operation, in a case where operation of the operating member is predicted to be operated by the operation prediction unit.

In addition, in the operation support apparatus of this aspect of the invention, the operator may be a driver of a vehicle, and the musculoskeletal status detection unit, the operating member, the activating mechanism and the control unit may be installed in the vehicle.

In addition, in the operation support apparatus of this aspect of the invention, the musculoskeletal status information acquisition unit may acquire the musculoskeletal status information of an extremity of the driver in contact with the operating member.

In addition, in the operation support apparatus of this aspect of the invention, the musculoskeletal status information acquisition unit may acquire the musculoskeletal status information of a portion of the body below a head of the driver.

In addition, in the operation support apparatus of this aspect of the invention, the operating member may be a member to be used by the driver for controlling the activating mechanism that controls vehicle motion, and the mechanism control unit may execute an auxiliary control on the vehicle motion occurring due to operation of the operating member.

In addition, the operation support apparatus of this aspect of the invention may be further provided with a storage unit. The storage unit may be provided with a physical musculoskeletal information storage unit for storing physical musculoskeletal information at least including a motion range constraint condition of a extremity or a portion of the body below a head determined on the basis of a range of motion of joints of the driver, and the operation prediction unit may refer to the motion range constraint condition stored in the physical musculoskeletal information storage unit and predict whether the operating member is operated by the driver based on the musculoskeletal status information acquired by the musculoskeletal status information acquisition unit.

In addition, in the operation support apparatus of this aspect of the invention, the operating member may include a steering wheel, the activating mechanism may include a steering mechanism, and the mechanism control unit may execute torque-assist control for the steering mechanism that operates in response to the operation of the steering wheel by the driver.

In addition, in the operation support apparatus of this aspect of the invention, a motion range constraint condition may include an elbow joint motion range constraint condition defined based on a motion range of elbows of the driver, and the operation prediction unit may predict a direction in which the steering wheel is operated by the driver, based on the musculoskeletal status information acquired by the musculoskeletal status information acquisition unit by referring to the elbow joint motion range constraint condition stored in the physical musculoskeletal information storage unit.

In addition, in the operation support apparatus of this aspect of the invention, in a case where the direction of the operation of the steering wheel is predicted by the operation prediction unit, the mechanism control unit may execute play-reduction processing of gears of the steering mechanism so as to operate in the predicted direction of the operation prior to the steering wheel being operated, or impart torque to the steering mechanism so as to operate in the predicted direction either at timing of the operation of the steering wheel predicted by the operation prediction unit or at timing at which the steering wheel is operated by the driver.

In addition, in the operation support apparatus of this aspect of the invention, the operating member may include a brake pedal, the activating mechanism may include a braking mechanism, and the mechanism control unit may execute braking assist control for the braking mechanism operating in response to the operation of the brake pedal by the driver.

In addition, in the operation support apparatus of this aspect of the invention, a motion range constraint condition may include a leg joint motion range constraint condition defined based on a range of motion of at least one of a knee joint and a hip joint of the driver, and the operation prediction unit may predict whether the brake pedal is operated by the driver based on the musculoskeletal status information acquired by the musculoskeletal status information acquisition unit and the leg joint motion range constraint condition stored in the physical musculoskeletal information storage unit.

In addition, in the operation support apparatus of this aspect of the invention, in a case where the operation of the brake pedal is predicted by the operation prediction unit, the mechanism control unit may execute oil pressurization processing so as to eliminate an insensitive range of the braking mechanism prior to the brake pedal being operated, or may execute the oil pressurization processing on the braking mechanism so that the braking mechanism operates either at timing at which the brake pedal has been predicted to be operated by the operation prediction unit or at timing at which the brake pedal is operated by the driver.

In addition, the operation support method as claimed in one aspect of the invention has processes: a musculoskeletal status information acquisition process of acquiring a musculoskeletal status information relating to a musculoskeletal status of an operator; an operation prediction process for predicting whether an operating member is operated by the operator based on the musculoskeletal status information acquired in the musculoskeletal status information acquisition process; and a mechanism control process for, in a case where an operation of the operating member is predicted in the operation prediction process, either executing, a preprocessing operation of an actual operation of the activating mechanism that is response to the operation of the operating member prior to the operation of the operating member or initiating the actual operation of the activating mechanism.

In addition, in the operation support method of this aspect of the invention, the operator may be a driver of a vehicle, and the musculoskeletal status information acquisition process, the operation prediction process and the mechanism control process may be executed in the vehicle.

In addition, the operation support method of this aspect of the invention may acquire the musculoskeletal status information of an extremity of the driver in contact with the operating member in the musculoskeletal status information acquisition process.

In addition, the operation support method of this aspect of the invention may acquire musculoskeletal status information of a portion of the body below a head of the driver in the musculoskeletal status information acquisition process.

In addition, in the operation support method of this aspect of the invention, an auxiliary control may be execute for the activating mechanism that controls vehicle motion in response to the operation of the operating member in the mechanism control process.

In addition, the operation support method of this aspect of the invention may predict whether the operating member is operated by the driver in the operation prediction process based on the musculoskeletal status information acquired in the musculoskeletal status information acquisition process and a motion range constraint condition of an extremity or a portion of the body below a head of the driver defined based on a range of motion of joints of the driver.

In addition, in the operation support method of this aspect of the invention, the operating member may include a steering wheel, the activating mechanism may include a steering mechanism, and in the mechanism control process, torque assist control on the steering mechanism that operates in response to the operation of the steering wheel by the driver may be executed.

In addition, in the operation support method of this aspect of the invention, a motion range constraint condition may include an elbow joint motion range constraint condition defined based on a motion range of an elbow joint of the driver, and in the operation prediction process, a direction in which the steering wheel is operated by the driver may be predicted based on the musculoskeletal status information acquired in the musculoskeletal status information acquisition process and the elbow joint motion range constraint condition.

In addition, in the operation support method of this aspect of the invention, in a case where a direction of the operation of the steering wheel is predicted in the operation prediction process, either play-reduction processing of gears of the steering mechanism may be executed in the mechanism control process so as to operate in the predicted direction of the operation prior to the steering wheel being operated, or torque be imparted to the steering mechanism so as to operate in the predicted direction either at timing of the operation of the steering wheel predicted in the operation prediction process or at timing at which the steering wheel is operated by the driver.

In addition, in the operation support method of this aspect of the invention, the operating member may include a brake pedal, the activating mechanism may include a braking mechanism, and in the mechanism control process, braking assist control may be executed on the braking mechanism that operates in response to the operation of the brake pedal by the driver in the mechanism control process.

In addition, in the operation support method of this aspect of the invention, a motion range constraint condition may include a leg joint motion range constraint condition defined based on a range of motion of at least one of a knee joint and a hip joint of the driver, and in the operation prediction process, whether the brake pedal is operated by the driver may be predicted based on the musculoskeletal status information acquired in the musculoskeletal status information acquisition process and the leg joint motion range constraint condition.

In addition, in the operation support method of this aspect of the invention, in a case where the operation of the brake pedal is predicted in the operation prediction process, either oil pressurization processing may be executed in the mechanism control process so as to eliminate an insensitive range of the braking mechanism prior to the brake pedal being operated, or the oil pressurization processing may be executed on the braking mechanism so that the braking mechanism operates at timing at which the brake pedal has been predicted to be operated in the operation prediction process or at timing at which the brake pedal is operated by the driver.

According the operation support apparatus of this aspect as described above, the musculoskeletal status detection unit acquires musculoskeletal status information of an operator. An operation prediction unit then predicts whether or not an operating member will be operated by the operator based on the acquired musculoskeletal status information. In the case it has been predicted that the operating member will be operated, either a preprocessing operation of actual operation of the activating mechanism is executed prior to the operating member being operated or actual operation is initiated. Consequently, “preliminary” operations (namely, “body motion (movement)”) of an operation by the operator can be monitored, those portions serving as “signs” directly related to operation can be extracted, prediction of the operation by the operator and the probability thereof can be calculated, and an activating mechanism can be suitably controlled on the basis of the predicted results. For example, according to this aspect, since a “sign” in the form of operation of the operating member can be extracted based on movement of the skeleton of the operation, operation of an activating mechanism (such as play reduction or an actual operation) can be initiated at the time that “sign” is detected. In addition, according to this aspect, since a “delay element” can be eliminated by accurately detecting operations by the operator, support control can be initiated at a good response rate and with little waste. As a result, this aspect is able to realize safe and comfortable activating mechanism control.

In addition, in the case of applying the operation support apparatus of this aspect of the invention to a vehicle, “preliminary” operations (namely, “body motion (movement)”) of driving by a driver of the vehicle can be monitored, those portions serving as “signs” directly related to driving operation can be extracted, prediction of driving operations by the vehicle driver and the probability thereof can be calculated, and vehicle motion can be suitably controlled based on the predicted results. For example, according to this aspect, since a “sign” in the form of operation of an operating member can be extracted based on movement of the skeleton of the driver, operation of an activating mechanism (such as play reduction or an actual operation) can be initiated at the time that “sign” is detected. In addition, according to this aspect, since a “delay element” can be eliminated by accurately detecting operations by the driver, support control can be initiated at a good response rate and with little waste, thereby making it possible to realize safe and comfortable vehicle motion control.

In addition, according to this aspect of the invention, musculoskeletal status information is acquired for an extremity of a vehicle driver in contact with an operating member. Consequently, in comparison with the case of estimating musculoskeletal status information based on information relating to movement of parts of the body other than an extremity in contact with the operating member (such as the line of inclination of the shoulders or orientation of the chest), data can be extracted from, for example, the status of the body in contact with the operating member. As a result, movement of the body directed related to operation can be depicted, and operation can be estimated more accurately based on physical musculoskeletal status information.

In addition, according to this aspect of, the invention, since musculoskeletal status information is acquired for a portion of the body below the head of the driver, the status of the vehicle driver can be predicted more accurately than existing control technology that predicts the status of a driver by detecting the orientation of the face, such as a “vehicle driver facial orientation alarm” utilizing JP-A-2006-123640. For example, in the case of control technology for detecting orientation of the face (facial orientation detection control), in the case an operator or driver has operated an operating member while his or her face is facing in a direction unrelated to operation (such as when glancing to the side during operation or driving), an operation unintended by the operator or driver may be incorrectly estimated. However, according to this aspect of the invention, by depicting movement of the skeleton involved in actual operation of an operating member, an operation can be estimated based on musculoskeletal status information of a portion of the body below the head of the driver (portion of the body below the shoulders). As a result, this aspect of the invention is able to predict the status of the vehicle driver with higher accuracy than the above-mentioned “facial orientation detection control”.

In addition, according to this aspect of the invention, the operating member is a member used by the driver to operate an activating mechanism that controls vehicle motion, and auxiliary control is executed on vehicle motion that occurs as a result of operation of the operating member. Consequently, by initiating an activating mechanism at the appropriate timing (including rapid initiation), auxiliary control can be carried out such as gear play reduction or imparting assist torque in the case of a steering mechanism, for example. As a result, this aspect of the invention is able to eliminate as much of the above-mentioned “delay element” as possible.

In addition, according to this aspect of the invention, physical musculoskeletal information, at least including motion range constraint condition of an extremity or portion of the body below the head defined based on the range of motion of joints of the driver, is stored in a storage unit, and whether or not the operating member is operated by the driver is predicted based on the acquired musculoskeletal status information and the motion range constraint condition stored in the storage unit. As a result, estimation of status directly related to actual activation and operation of the operating member by the driver for safe vehicle motion control can be carried out with high accuracy. In addition, according to this aspect, operation of a driving operation system (operating member) can be predicted from range of motion information of an extremity or portion of the body below the head of the driver and information on the current musculoskeletal status of the driver, and operation of an activating mechanism can be initiated in the case the activating mechanism has been predicted to be operated. As a result, since an operation of the driver can be detected accurately and a “delay element” can be eliminated, this aspect of the invention is able to initiate support control with a good response time and little waste, thereby making it possible to realize safe and comfortable vehicle motion control.

In addition, according to this aspect of the invention, the operating member includes a steering wheel, the activating mechanism includes a steering mechanism, and torque assist control is executed on the steering mechanism that operates in response to operation of the steering wheel by the vehicle driver. Consequently, the steering mechanism can be operated more rapidly by imparting steering assist torque during emergency avoidance, for example. As a result, this aspect is able to realize safe and comfortable vehicle motion control.

In addition, according to this aspect of the invention, the motion range constraint condition include elbow joint motion range constraint condition defined based on the range of motion of the elbow joint of the driver, and the direction in which the steering wheel is operated by the driver is predicted based on acquired musculoskeletal status information by referring to the elbow joint motion range constraint condition stored in a storage unit. Consequently, an emergency avoidance operation in which the driver suddenly turns the steering wheel to avoid an obstacle, for example, can be predicted in advance. More specifically, according to this aspect, which direction the driver turns the steering wheel and whether or not an emergency avoidance operation is carried out to avoid an obstacle such as a vehicle or building can be accurately predicted by considering the range of motion of the elbow joint.

In addition, according to this aspect of the invention, in the case the direction in which the steering wheel will be operated has been predicted, either play-reduction processing on gears of the steering mechanism is executed so as to operate in the predicted direction of operation is executed, or torque is imparted to the steering mechanism at the timing at which operation of the steering wheel has been predicted by a control unit or at the timing at which the steering wheel is operated by the driver, prior to the steering wheel being operated. Consequently, in the case it has been predicted in advance that, for example, the driver will carry out an emergency avoidance operation to avoid an obstacle by suddenly turning the steering wheel, emergency avoidance can be carried out rapidly by activating the steering mechanism. As a result, this aspect is able to more reliably ensure driver safety. More specifically, according to this aspect, the sense of incongruence resulting from a time lag (delay) and the like from the time the steering wheel is operated to definitive initiation of operation of the steering mechanism, which occurs due to the presence of play in the steering mechanism, can be eliminated. As a result, this aspect is able to carry out safer and more comfortable steering control (steering assist) by diminishing limits on control attributable to delay in this manner.

In addition, according to this aspect of the invention, the operating member includes a brake pedal, the activating mechanism includes a braking mechanism, and braking assist control is executed on the braking mechanism that operates in response to operation of the brake pedal by the driver. Consequently, the braking mechanism can be operated more rapidly by assisting the braking mechanism with oil pressurization processing during emergency avoidance, for example. As a result, this aspect is able to realize safe and comfortable vehicle motion control.

In addition, according to this aspect of the invention, motion range constraint condition include leg joint motion range constraint condition defined based on the range of motion of at least one of the knee joint and the hip joint of the driver, and whether or not the driver operates the brake pedal is predicted based on acquired musculoskeletal status information and the leg joint motion range constraint condition stored in the storage unit. Consequently, an emergency avoidance operation for avoiding a collision with an obstacle and the like by the driver suddenly pressing on the brake pedal, for example, can be predicted in advance. More specifically, according to this aspect, whether or not an emergency avoidance operation is carried out to avoid a collision with an obstacle such as a vehicle or a building by the driver suddenly pressing on the brake pedal can be accurately predicted by considering the range of motion of the knee joint or the hip joint.

In addition, according to this aspect of the invention, in the case it has been predicted that the brake pedal will be operated, either oil pressurization processing is executed so as to eliminate an insensitive range of the braking mechanism prior to the brake pedal being operated, or the oil pressurization processing is executed on the braking mechanism so that the braking mechanism operates either at the timing at which the brake pedal has been predicted to be operated by the control unit or at the timing at which the brake pedal is operated by the driver. Consequently, in the case it has been predicted in advance that an emergency avoidance operation will be carried out for avoiding a collision with an obstacle and the like by the driver suddenly pressing on the brake pedal, the emergency avoidance operation can carried out by rapidly activating the braking mechanism. More specifically, according to this aspect, the sense of incongruence resulting from a time lag (delay) and the like from the time the brake pedal is operated to actual initiation of operation of the braking mechanism, which occurs due to the presence of play in the braking mechanism, can be eliminated. As a result, this aspect is able to carry out safer and more comfortable brake control (braking assist) by diminishing limits on control attributable to delay in this manner. As a result, the safety of the driver can be more reliably ensured.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a flow chart showing an example of basic processing of the invention;

FIG. 2 is a block diagram showing an example of the configuration of an operation support apparatus 100 to which the invention is applied;

FIG. 3 is a flow chart showing an example of steering assist control processing in the embodiment.

FIG. 4 is a flow chart showing an example steering assist control processing in the embodiment.

FIG. 5 is a drawing showing an example of the status of a vehicle driver during steering assist control in the embodiment;

FIG. 6 is a flow chart showing an example of braking assist control processing in the embodiment;

FIG. 7 is a flow chart showing an example of braking assist control processing in the embodiment; and

FIG. 8 is a drawing showing an example of the status of a vehicle driver during braking assist control in the embodiment.

### DETAILED DESCRIPTION OF EMBODIMENTS

The following provides a detailed explanation of embodiments of the operation support apparatus, operation support method and program as claimed in the invention based on the drawings. Furthermore, this invention is not limited by these embodiments.

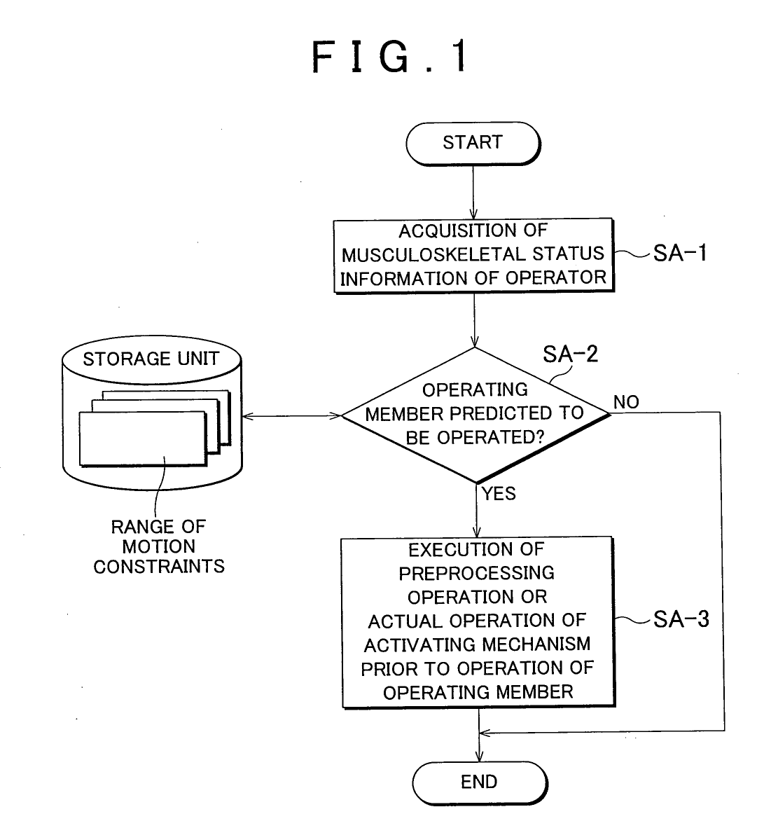

The following first provides an explanation of a summary of a embodiment of the invention with reference to FIG. 1, followed by a detailed explanation of the configuration, processing and the like. Here, FIG. 1 is a flow chart showing an example of basic processing.

Overall, the summary of the embodiment of the invention has the basic characteristics indicated below.

Namely, the operation support apparatus is at least provided with a musculoskeletal status detection unit for detecting the musculoskeletal status of an operator, an operating member of a vehicle that is operated by the operator, an activating mechanism that operates in response to operation of the operating member, a control unit and a storage unit.

Here, the “operating member” refers to a member used by the operator to operate the activating mechanism, and for example, includes an operating lever, an operating switch or an operating pedal.

In addition, the “activating mechanism” refers to a mechanism that operates in response to the amount of operation of the operating member, and for example, includes a robot arm that operates in response to the amount of operation of an operating lever, operating switch or operating pedal.

In addition, the storage unit may store physical musculoskeletal information at least including motion range constraint conditions of an extremity or portion of the body below the head based on the range of motion of joints of the operator. In addition, the motion range constraint conditions may further include elbow joint motion range constraint conditions defined based on the range of motion of the elbow joint of the operator. In addition, the motion range constraint conditions may also further include leg joint motion range constraint conditions defined based on the range of motion of at least one leg joint consisting of the knee joint and the hip joint of the operator.

The following provides an explanation of an example of basic processing of the operation support apparatus with reference to FIG. 1.

As shown in FIG. 1, the control unit of the operation support apparatus acquires musculoskeletal status information by controlling the musculoskeletal status detection unit (Step SA-1).

Here, the control unit of the operation support apparatus may acquire musculoskeletal status information of an extremity of the operator in contact with an operating member. In addition, the control unit of the operation support apparatus may also acquire musculoskeletal status information of a portion of the body below the head of the operator.

The control unit of the operation support apparatus predicts whether or not the operating member will be operated by the operator based on the musculoskeletal status information acquired in Step SA-1 (Step SA-2).

Here, the control unit of the operation support apparatus may also predict whether or not the operating member will be operated by the operator based on the acquired musculoskeletal status information and motion range constraint conditions stored in the storage unit. In addition, the control unit of the operation support apparatus may also predict the direction in which the operating member will be operated by the operator based on the acquired musculoskeletal status information and elbow joint motion range constraint conditions stored in the storage unit. In addition, the control unit of the operation support apparatus may also predict whether or not an operating pedal and the like will be operated by the operator based on the acquired musculoskeletal status information and leg joint motion range constraint conditions stored in the storage unit.

In the case it has been predicted in Step SA-2 that the operating member will be operated (Yes in Step SA-2), the control unit of the operation support apparatus either executes a preprocessing operation (such as reducing play until a robot arm operates by operating an operating lever) of an actual operation (such as extending the robot arm and grabbing an object) of an activating mechanism (such as a robot arm) prior to the operating member being operated, or initiates the actual operation (such as beginning to extend the robot arm) (Step SA-3).

Here, the “preprocessing operation” does not refer to an “actual operation” itself carried out by an activating mechanism, but rather to a step essential for actual operation of the activating mechanism. For example, the preprocessing operation includes play-reduction processing of the gears of the robot arm, imparting of assist torque to the robot arm in the direction in which it has been predicted to operate, or preliminary oil pressurization processing to eliminate an insensitive range of an operating pedal. For example, in the case it has been determined that an operating lever or operating pedal will be operated by detecting movement of the skeleton of the operator, the control unit of the operation support apparatus may initiate a preprocessing operation in the form of play reduction or may initiate the imparting of a slight torque assist in the direction in which the robot arm is actually operated.

In addition, the control unit of the operation support apparatus may also execute auxiliary control (such as initiating a preprocessing operation or initiating actual operation) for operation of the activation mechanism that occurs due to operation of the operating member.

In addition, the control unit of the operation support apparatus may also execute auxiliary control in the form of torque assist control for a robot arm that operates in response to operation of an operating lever or operating pedal by an operator. As a specific example thereof, in the case the direction in which an operating lever will be operated has been predicted, the control unit of the operation support apparatus either executes play-reduction processing of gears of the robot arm so as to operate in predicted direction prior to the operating lever being operated, or imparts torque in the form of torque assist control to the robot arm so as to operated in the predicted direction of operation as an actual operation at the timing at which the operating lever has been predicted to be operated or at the timing at which the operating lever has been operated by the operator.

In addition, the control unit of the operation support apparatus may also execute assist control for the robot arm that operates in response to operation of an operating pedal (such as using the end of the robot arm to grab an object) by the operator. More specifically, in the case it has been predicted that the operating pedal will be operated, the control unit of the operation support apparatus may either execute as an actual operation a preprocessing operation in the form of oil pressurization processing so as to eliminate an insensitive range of the brake pedal prior to the brake pedal being operated, or may execute the oil pressurization processing on the robot arm so that the robot arm operates in the form of assist control either at the timing at which the brake pedal has been predicted to be operated by the control unit or at the timing at which the brake pedal is operated by the operator.

On the other hand, in the case it has been predicted that the operating member will not be operated in Step SA-2 (No in Step SA-2), the control unit of the operation support apparatus ends processing. This completes an explanation of the basic processing of the operation support apparatus.

This concludes an explanation of the summary of the embodiment of the invention.

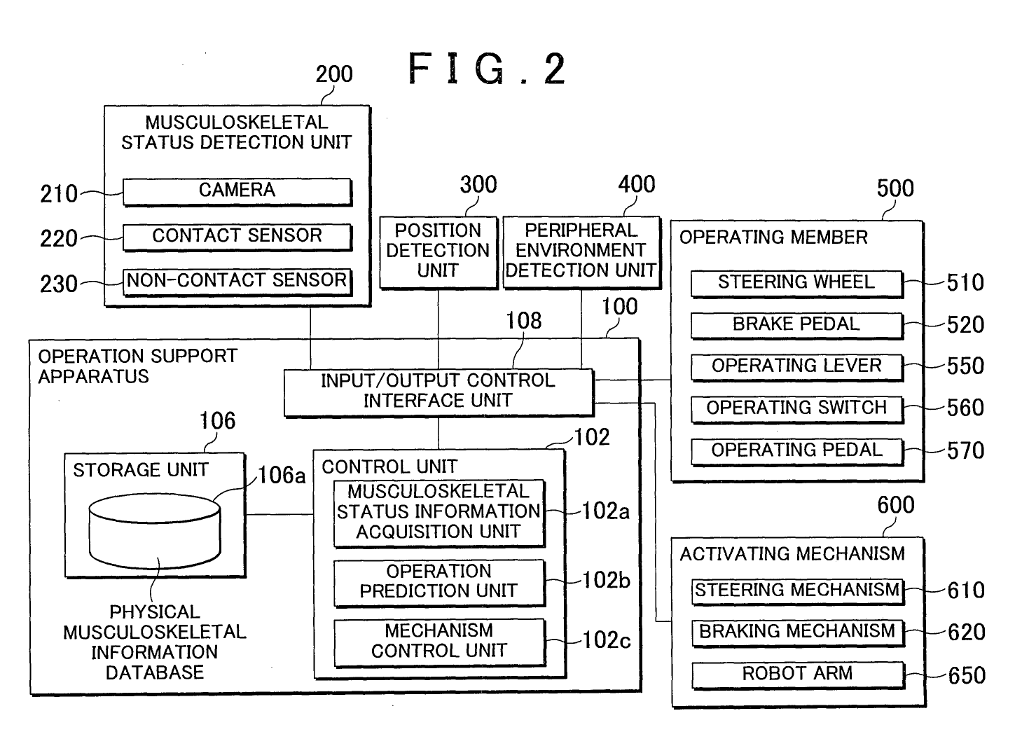

The following provides an explanation of the configuration of the operation support apparatus 100 with reference to FIG. 2. FIG. 2 is a block diagram showing an example of the configuration of the operation support apparatus 100 to which the invention is applied, and only those portions of the configuration that are related to the invention are shown conceptually.

As shown in FIG. 2, overall the operation support apparatus 100 is connected to a musculoskeletal status detection unit 200 for detecting the musculoskeletal status of an operator (including a driver of a vehicle), an operating member 500 operated by the operator, an activating mechanism 600 that operates in response to operation of the operating member 500, a position detection unit 300, and a peripheral information detection unit 400, and is composed by at least being provided with a control unit 102 and a storage unit 106.

In FIG. 2, the operating member 500 is a member used by the operator for operating the activating mechanism 600 (such as a robot arm 650), and includes, for example, an operating lever 550, an operating switch 560 and an operating pedal 570 and the like. In addition, in the case of vehicle motion control, the operating member 500 is a member used by a driver to operate the activating mechanism 600 that controls vehicle motion (such as starting out, stopping, going around a curve and accelerating or decelerating), and includes, for example, a brake pedal 520, an accelerator pedal, a steering wheel 510, a shift lever, switches, dials and buttons. In this embodiment, the operating member 500 has the function of operating the activating mechanism 600 that operates in response to an amount of operation of the operating member 500, and includes, for example, an operating lever 550 for controlling the robot arm 650, an operating switch 560 and an operating pedal 570. In addition, in the case of vehicle motion control, the operating member 500 includes a steering wheel 510 for controlling a steering mechanism 610, and a brake pedal 520 for controlling a braking mechanism 620.

In addition, in FIG. 2, the activating mechanism 600 is a mechanism that operates in response to an amount of operation of the operating member 500, and includes, for example, the robot arm 650 that operates in response to an amount of operation of the operating member 500 such as the operating lever 550, the operating switch 560 or the operating pedal 570. In addition, in the case of vehicle motion control, the activating mechanism 600 is an actuator that carries out vehicle control based on estimation results of movements and operations of the vehicle driver. For example, the steering mechanism 610 is a steering torque assist actuator that either imparts torque in a predicted direction of operation or carries out play-reduction processing and the like on the gears. In addition, the braking mechanism 620, for example, is a braking assist actuator that carries out oil pressurization processing and the like for an insensitive region (containing play) of the brakes.

In addition, in FIG. 2, the musculoskeletal status detection unit 200 functions as a sensor for monitoring movements made by the operator that detects the musculoskeletal status of the operator (including a vehicle driver), and is composed by at least being provided with, for example, a camera 210, a contact sensor 220 and a non-contact sensor 230.

Here, the camera 210 has the function of an operator monitor camera that captures image information (including animated images) for allowing the control unit 102 to measure inter-joint link length and the like by monitoring joint positions and movement thereof of the operator, and is installed at an arbitrary location that enables images of the operator to be captured (such as on a rearview mirror in the case of a vehicle). More specifically, image information of the operator captured by the camera 210 is used to detect inclination of the shoulder line or angle of inclination of the torso and the like as a result of the control unit 102 processing the image information by binary processing and the like. In this embodiment, the camera 210 captures image information used to detect the inclination of the shoulder line or angle of inclination of the torso and the like by having the control unit 102 monitor the positions of each joint of the operator. Furthermore, the camera 210 may also be composed of a plurality of cameras 210-1 to 210-2, and for example, images of the knee and hip joints of the operator may be captured with one of the cameras 210-1, while images of the joints of the elbow and wrist may be captured with the other camera 210-2. In addition, the camera 210 may also be, for example, an infrared camera. Here, since the an infrared camera is able to capture images of the driver at night without requiring illumination, the camera 210 may also have the function of being able to capture spatial temperature distribution, including that of the elbow, knee and hip joints of the operator.

In addition, the contact sensor 220 has the function of a contact-type motion sensor for directly sensing movement of the operator, and is installed on the operating member 500 that contacts the operator (such as on the operating lever 550, or the steering wheel 510 or seat occupied by the operator in the case of a vehicle). For example, the contact sensor 220 may include a torque sensor or pressure sensor (including a seat pressure sensor and the like). More specifically, the torque sensor is installed at an arbitrary location of the operating member 500 (such as on the operating lever 550 or on the steering wheel 510 in the case of a vehicle), and detects torque applied in the direction in which the operating member 500 (such as the operating lever 550 or the steering wheel 510 in the case of a vehicle) is operated. In addition, the pressure sensor is installed at an arbitrary location such as the seat occupied by the operator, and detects a load applied to the seat that fluctuates when the operator carries out an operation.

In addition, the non-contact sensor 230 has the function of a non-contact-type motion sensor for sensing contact and non-contact of the body with the operating member 500 being operated (for example, the operating lever 550, the operating switch 560, the operating pedal 570, or in the case of a vehicle, the steering wheel 510 or the brake pedal 520), and is installed on the operating member 500 operated by the operator. For example, the non-contact sensor 230 includes an electrostatic capacitance sensor and the like. More specifically, the non-contact sensor 230, for example, detects the proximity of a foot by detecting fluctuations in electrostatic capacitance detected from the body in the case the foot of the operator has approached the brake pedal 520 or the operating pedal 570 beyond a normal position.

In addition, in FIG. 2, the position detection unit 300 has the function of generating current position information by specifying the current position of a host vehicle with high precision primarily during vehicle motion control. For example, the position detection unit 300 is provided with a geomagnetic sensor, gyro compass or steering sensor and the like, and these can be used to detect current position of the host vehicle and road conditions by an autonomous navigation method. In addition, the position detection unit 300 can also be provided with a GPS antenna or GPS receiver and the like, and these can be used to detect current position of the host vehicle, road conditions and the like by a radio navigation method. In this embodiment, current position information and the like detected with the position detection unit 300 is used to enhance prediction accuracy by integrating with musculoskeletal status information acquired by the control unit 102.

In addition, in FIG. 2, the peripheral information detection unit 400 has the function of generating peripheral information indicating a positional relationship between a target object in the periphery of the host vehicle and the host vehicle primarily during vehicle motion control. For example, the peripheral information detection unit 400 may be provided with a camera (such as a rearview guide camera or front and side monitor) or milliwave radar and the like for recognizing a positional relationship between the host vehicle and the target object. In this embodiment, peripheral information detected with the peripheral information detection unit 400 is used to enhance prediction accuracy by integrating with musculoskeletal status information acquired by the control unit 102.

In this embodiment, the position detection unit 300 and the peripheral information detection unit 400 are used to monitor the current environment surrounding the vehicle and acquire peripheral environment information of the vehicle (including position information and peripheral information). The acquired peripheral environment information is used as criteria for determining the reliability of estimation results of movements and operations carried out by the driver (such as the possibility of steering to the right when there is a vehicle to the front and right of the host vehicle) as a result of processing by the control unit 102.

In addition, in FIG. 2, an input/output control interface unit 108 is an interface connected to the above-mentioned musculoskeletal status detection unit 200, the position detection unit 300, the peripheral information detection unit 400, the operating member 500 and the activating mechanism 600. In addition, the input/output control interface unit 108 has the function of controlling input and output of information such as signals obtained from the musculoskeletal status detection unit 200, the position detection unit 300, the peripheral information detection unit 400, the operating member 500 and the activating mechanism 600.

In addition, in FIG. 2, various types of databases or tables (such as physical musculoskeletal information database 106a) housed in the storage unit 106 are storage devices such as a hard disk drive. For example, the storage unit 106 houses various types of programs, tables, files and databases used for various types of processing, information required for predicting operations by the operator (including a driver) (such as the antagonistic balance between physical joint constraints (range of motion) and muscle (such as the strength of flexure and extension for each joint)), and in the case of vehicle motion control, information required for vehicle travel (such as maps, straight sections of road, curves, on and off ramps, expressways and the like).

Among each of the constituent features of the storage unit 106, the physical musculoskeletal information database 106a is used when predicting whether or not the operator will operate the operating member 500 based on musculoskeletal status information acquired by the control unit 102, and is a physical musculoskeletal information storage unit for storing physical musculoskeletal information at least containing motion range constraint conditions for an extremity or portion of the body below the head defined based on the range of motion of the joints of the operator. In addition, the physical musculoskeletal information database 106a may also include musculoskeletal data relating to the antagonistic balance between physical joint constraints (range of motion) and muscle (such as the strength of flexure and extension of each joint) in the physical musculoskeletal information. In addition, the physical musculoskeletal information database 106a may further contain elbow joint motion range constraint conditions defined based on the range of motion of the elbow joint of the operator as well as leg joint motion range constraint conditions defined based on the range of motion of at least one leg joint among the knee joint and the hip joint of the operator.

In addition, in FIG. 2, the control unit 102 has a control program such as an operating system (OS) and internal memory for housing programs defining various types of processing procedures and required data. The control unit 102 processes information for executing various processing in accordance with these programs and the like. The control unit 102 is composed by being provided with a musculoskeletal status information acquisition unit 102a, an operation prediction unit 102b, and a mechanism control unit 102c. In this embodiment, the control unit 102 functions as an operator operation estimator, and functions as a module for estimating movements and operations of the operator based on information obtained from the musculoskeletal status detection unit 200, the position detection unit 300 and the peripheral information detection unit 400, and information stored in the storage unit 106.

Among these constituents, the musculoskeletal status information acquisition unit 102a acquires musculoskeletal status information of the operator (including a vehicle driver) by controlling the musculoskeletal status detection unit 200.

In addition, the operation prediction unit 102b predicts whether or not the operating member 500 will be operated by the operator (including a driver) based on musculoskeletal status information acquired by the musculoskeletal status information acquisition unit 102a.

In addition, in the case it has been predicted by the operation prediction unit 102b that the operating member 500 will be operated, the mechanism control unit 102c either executes a preprocessing operation for actual operation of the activating mechanism 600 prior to the operating member 500 being operated, or initiates the actual operation.

This concludes an explanation of the configuration of the operating support apparatus 100.

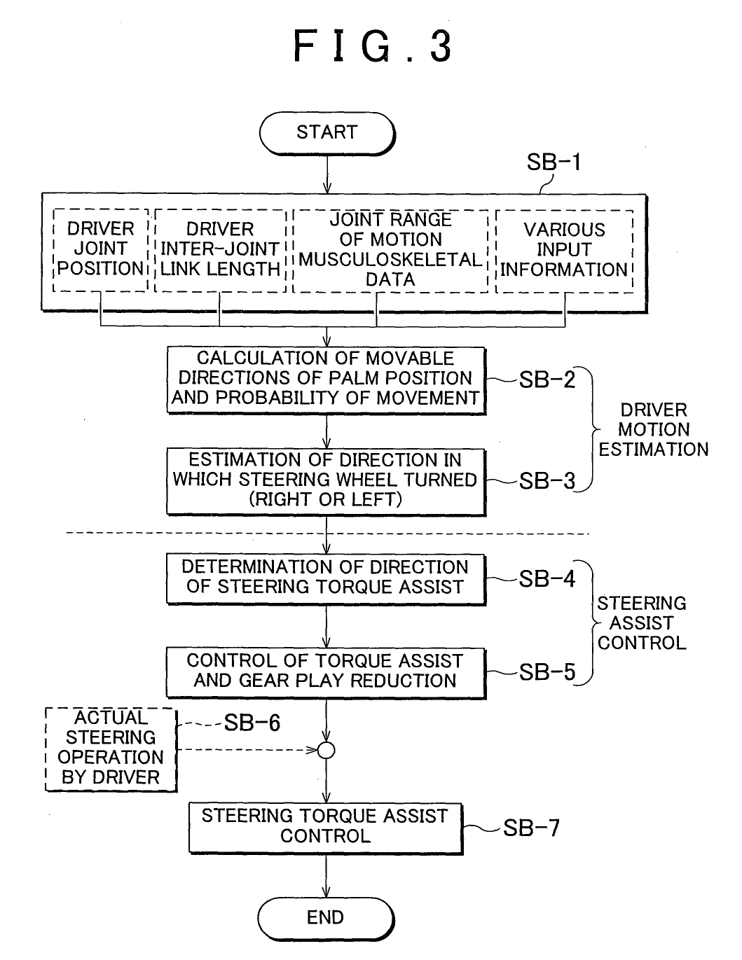

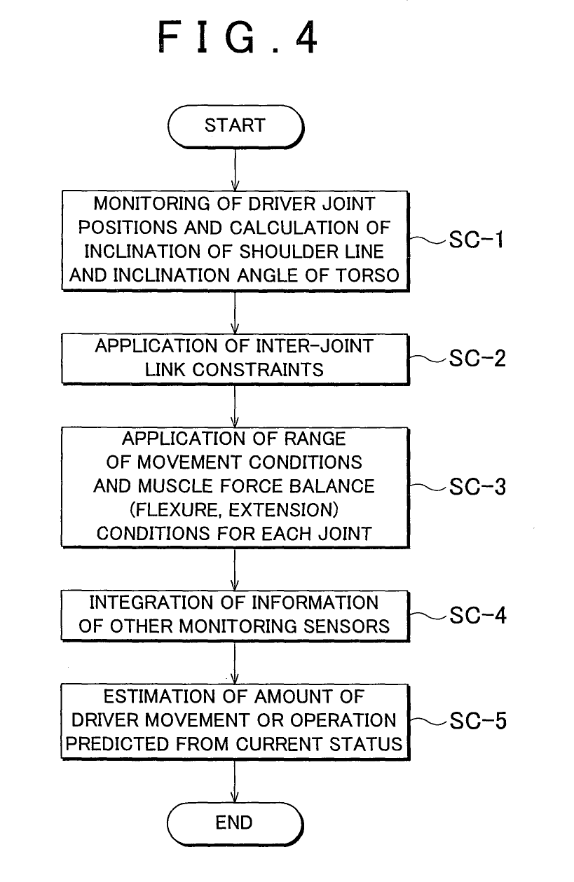

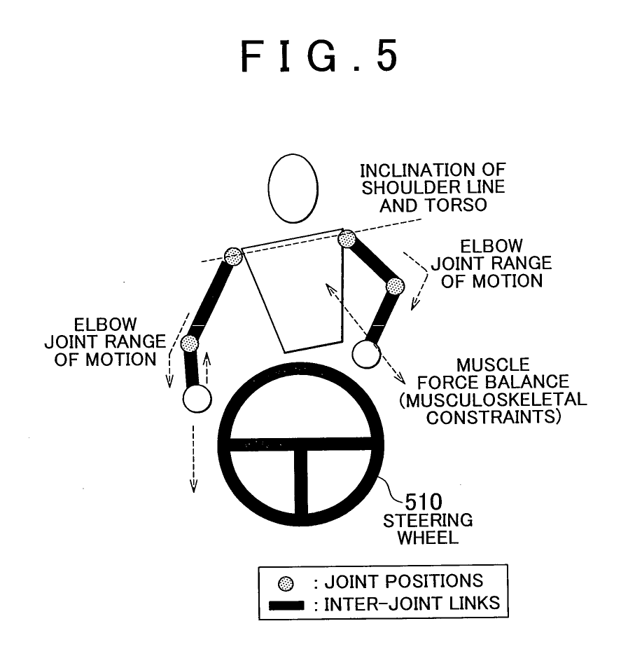

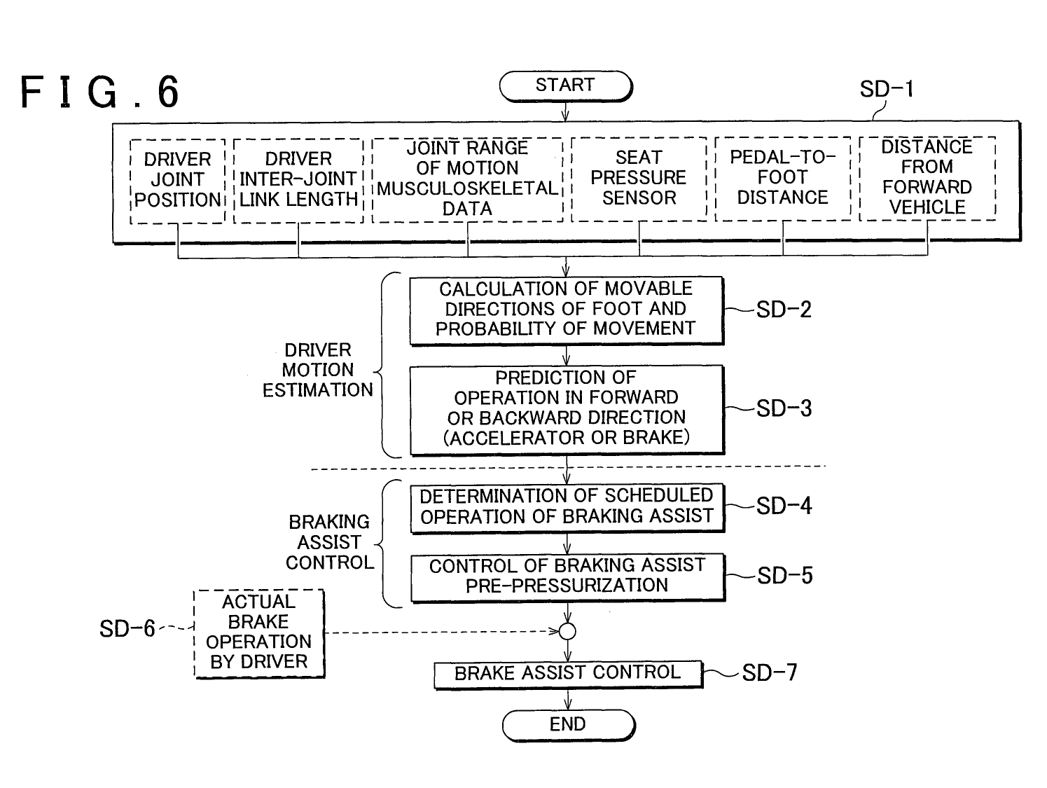

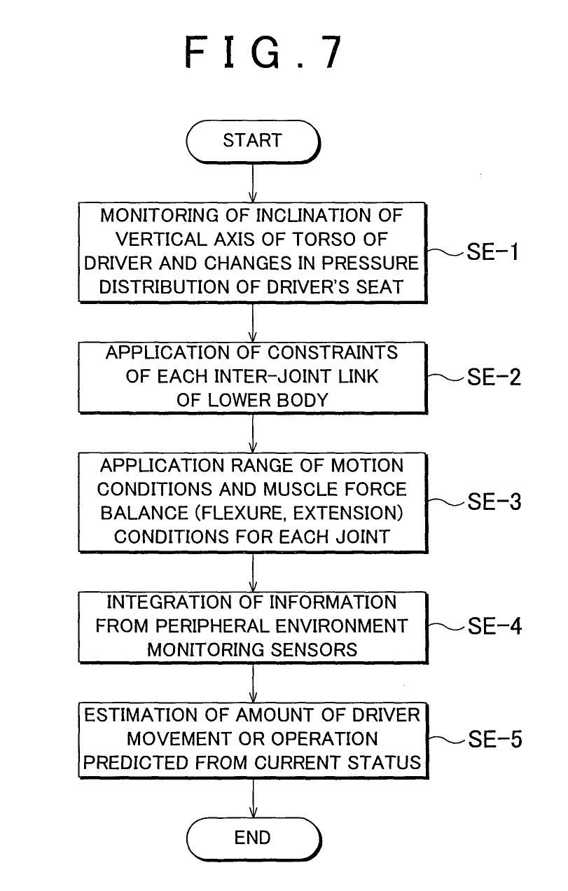

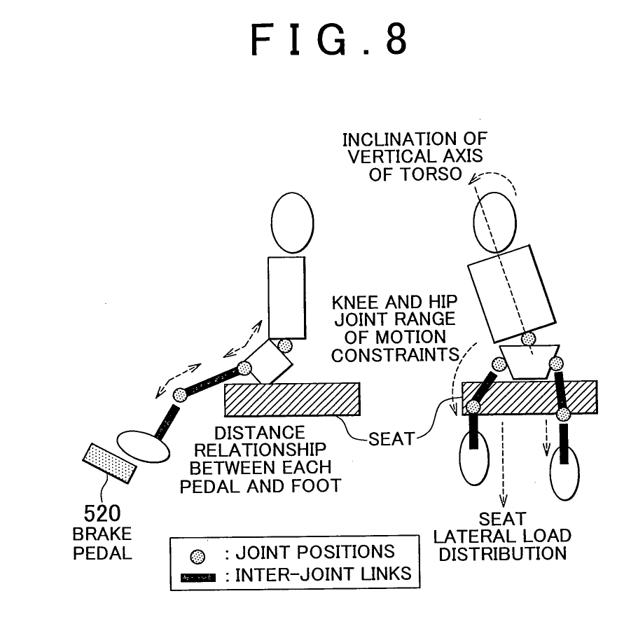

The following provides a detailed explanation of an example of processing by the operation support apparatus 100 applied to a vehicle in this embodiment composed in the manner described above with reference to FIG. 1 and FIGS. 3 to 8. Here, FIGS. 3 and 4 are flow charts showing an example of steering assist control processing in this embodiment. In addition, FIG. 5 is a drawing showing an example of the status of a vehicle driver during steering assist control in this embodiment. In addition, FIGS. 6 and 7 are flow charts showing an example of braking assist control processing in this embodiment. In addition, FIG. 8 is a drawing showing an example of the status of a vehicle driver during braking assist control in this embodiment.

First, as one example, detailed explanation is provided of an example of basic processing by the operation support apparatus 100 for an embodiment in which the operation support apparatus 100 is applied to a vehicle with reference to FIG. 1.

As shown in FIG. 1, the musculoskeletal status information acquisition unit 102a acquires musculoskeletal status information of an operator in the form of a driver by controlling the musculoskeletal status detection unit 200 (Step SA-1).

Here, the musculoskeletal status information acquisition unit 102a may also acquire musculoskeletal status information of an extremity of the operator or vehicle driver that contacts the operating member 500. In addition, the musculoskeletal status information acquisition unit 102a may also acquire musculoskeletal status information of a portion of the body below the head of the driver.

The operation prediction unit 102b predicts whether or not the operating member 500 will be operated by the driver based on musculoskeletal status information acquired by the processing of the musculoskeletal status information acquisition unit 102a in Step SA-1 (Step SA-2).

Here, the operation prediction unit 102b may also predict whether or not the operating member 500 will be operated by the vehicle driver based on musculoskeletal status information acquired by the processing of the musculoskeletal status information acquisition unit 102a by referring to motion range constraint conditions stored in the physical musculoskeletal information database 106a. In addition, the operation prediction unit 102b may also predict the direction in which the steering wheel 510 will be operated by the vehicle driver based on musculoskeletal status information acquired by the processing of the musculoskeletal status information acquisition unit 102a by referring to elbow joint motion range constraint conditions stored in the physical musculoskeletal information database 106a. In addition, the operation prediction unit 102b may also predict whether or not the brake pedal 520 will be operated by the vehicle driver based on musculoskeletal status information acquired by the processing of the musculoskeletal status information acquisition unit 102a by referring to leg joint motion range constraint conditions stored in the physical musculoskeletal information database 106a.

In the case it has been predicted by processing of the operation prediction unit 102b that the operating member 500 will be operated in Step SA-2 (Yes in Step SA-2), the mechanism control unit 102c either executes a preprocessing operation (such a play-reduction processing of the gears of the steering mechanism 610 or oil pressurization processing to eliminate an insensitive region in the braking mechanism 620) of actual operation (such as turning to the left or right of the steering mechanism 610 or oil pressurization of the braking mechanism 620) of the activating mechanism 600 (for example, the steering mechanism 610 and the braking mechanism 620) prior to the operating member 500 being operated, or initiates an actual operation (such as imparting torque to the steering mechanism 610 or pressurizing oil for actually activating the braking mechanism 620) (Step SA-3).

Here, the “preprocessing operation” in vehicle control does no refer to an “actual operation” by the activating mechanism 600 itself, but refers to a step essential for actually operating the activating mechanism 600. For example, the preprocessing operation includes play-reduction processing for the gears of the steering mechanism 610 or imparting assist torque during steering torque assist. For example, in the case it has been determined by processing of the operation prediction unit 102b that the steering wheel 510 will be operated by detecting movement of the skeleton of a driver, the operation prediction unit 102b may initiate play reduction or may initiate the slight imparting of torque assist in the direction in which the steering wheel 510 is actually operated.

In addition, the mechanism control unit 102c may execute auxiliary control (such as initiating a preprocessing operation or actual operation) for vehicle control occurring due to operation of the operating member 500.

In addition, the mechanism control unit 102c may also execute auxiliary control in the form of torque assist control for the steering mechanism 610 that operates in response to operation of the steering wheel 510 by the driver. More specifically, in the case it has been predicted that the steering wheel 510 will be operated, the mechanism control unit 102c may execute a preprocessing operation in the form of play-reduction processing on the gears of the steering mechanism 610 so as to operate in the predicted direction of operation prior to the steering wheel 510 being operated, or impart torque in the form of torque assist control to the steering mechanism 610 in the form of an actual operation so as to operate in the predicted direction of operation either at the timing at which the steering wheel 510 has been predicted to be operated or at the timing at which the steering wheel 510 is operated by the vehicle driver.

In addition, the mechanism control unit 102c may execute auxiliary control in the form of brake assist control on the braking mechanism 620 that operates in response to operation of the brake pedal 520 by the vehicle driver. More specifically, in the case it has been predicted that the brake pedal 520 will be operated, the mechanism control unit 102c may execute a preprocessing operation in the form of oil pressurization processing so as to eliminate an insensitive region of the braking mechanism 620 prior to the brake pedal 520 being operated, or may execute an actual operation in the form of executing oil pressurization processing on the braking mechanism 620 in the form of brake assist control so that the braking mechanism 620 operates either at the timing at which the brake pedal 520 has been predicted to be operated by the processing of the operation prediction unit 102b, or at the timing at which the brake pedal 520 is operated by the vehicle driver.

On the other hand, processing ends in the case the operating member 500 is predicted to not be operated by processing of the operation prediction unit 102c in Step SA-2 (No in Step SA-2). This concludes an explanation of the basic processing of the operation support apparatus 100 of the invention.

Continuing, an explanation is provided of an example of steering assist control processing in this embodiment by following the flow of the flow charts of FIGS. 3 and 4 and occasionally referring to FIG. 5.

As shown in FIG. 3, the musculoskeletal status information acquisition unit 102a acquires the current status of the vehicle driver and various types of constraints in the form of input information (Step SB-1). More specifically, the musculoskeletal status information acquisition unit 102a acquires joint positions of the driver and inter-joint link lengths of the driver from image information of the driver captured with the camera 210. In addition, the musculoskeletal status information acquisition unit 102a acquires joint range of motion data, musculoskeletal data and the like stored in the physical musculoskeletal information database 106a in the form of constraints. In addition, the musculoskeletal status information acquisition unit 102a may also acquire a portion of various input information such as information indicating movement of the driver detected with the contact sensor 220 (movement of the steering wheel 510) or information indicating the distance between the driver and the operating member 500 (such as the steering wheel 510 or the brake pedal 520) detected with the non-contact sensor 230. In addition, the control unit 102 may acquire a portion of various types of input information in the form of peripheral environment information of the host vehicle (such as current position of the host vehicle or distance from a forward vehicle) detected with the position detection unit 300 and the peripheral information detection unit 400. Furthermore, the processing of this Step SB-1 corresponds to the processing of Step SA-1 shown in FIG. 1.

The operation prediction unit 102b then derives the movement or operation having the highest probability of being carried out next from the current status of the vehicle driver by estimating driver motion based on the input information acquired in Step SB-1 (Steps SB-2 and SB-3). More specifically, in Step SB-2, the operation prediction unit 102b calculates the movable directions of the palm of the vehicle driver and the probability of movement. The operation prediction unit 102b then estimates whether the direction in which the steering wheel 510 will be turned is to the right or to the left. Furthermore, the processing of Steps SB-2 and SB-3 corresponds to Step SA-2 in FIG. 1.

The following provides an explanation of the processing of the operation prediction unit 102b in Steps SB-1 and SB-2 with reference to FIGS. 4 and 5.

As shown in FIG. 4, the operation prediction unit 102b measures the inclination of the shoulder line of the driver shown in FIG. 5 and the angle of inclination of the torso and the like by monitoring the position of each joint of the driver shown in FIG. 5 based on input information acquired in Step SB-1 (Step SC-1).

The operation prediction unit 102b then applies constraints of the inter-joint links of the driver shown in FIG. 5 (Step SC-2).

Next, the operation prediction unit 102b applies range of motion conditions for each joint of the driver and muscle force balance (flexure, extension) conditions as shown in FIG. 5 (Step SC-3). More specifically, the operation prediction unit 102b applies range of motion and muscle force balance of the elbow joints, shown in FIG. 5 (musculoskeletal constraints).

The operation prediction unit 102b then integrates information (corresponding to various types of input information acquired in Step SA-1) from other monitoring sensors (such as the position detection unit 300 and the peripheral information detection unit 400) acquired by the processing of the control unit 102 (Step SC-4). For example, the operation prediction unit 102b may integrate information by also adding data indicating the positional relationship between the host vehicle and surrounding vehicles.

Next, the operation prediction unit 102b estimates the movement of the driver and the amount of operation of the operating member 500 such as the steering wheel 510 from the current status (Step SC-5). More specifically, the operation prediction unit 102b estimates whether the direction in which the operating member 500 such as the steering wheel 510 will be to the right or to the left and the amount the operating member 500 is turned (amount of operation).

Returning to FIG. 3, the mechanism control unit 102c derives the appropriate direction of assist and amount of assist in the form of steering assist control based on the estimation results obtained in Steps SB-2 and SB-3 (Steps SB-4 and SB-5). More specifically, the operation prediction unit 102b determines the direction of steering assist torque in Step SB-4, and then controls torque assist in the determined direction or reduces play in the gears of the steering mechanism 610 in advance so as to diminish a sense of incongruence resulting from a delay that can cause a problem in assist control in Step SB-5. Furthermore, the processing of Steps SB-4 and SB-5 correspond to Step SA-3 in FIG. 1.

The mechanism control unit 102c then imparts assist torque in coordination with the timing at which operation is predicted to be initiated or the timing of an actual operation by the driver (Steps SB-6 and SB-7). More specifically, the operation prediction unit 102b either controls steering assist torque prior to the detection of an actual operation of the steering wheel 510 by the driver in Step SB-6 or controls steering assist torque in coordination with that timing in Step SB-7. Furthermore, the processing of Steps SB-6 and SB-7 corresponds to Step SA-3 in FIG. 1.

In this manner, a safer and more comfortable vehicle motion system (steering assist) that reduces a sense of incongruence of the vehicle driver and inhibits restriction divergence is constructed by the steering assist control processing described above. This concludes the explanation of steering assist control processing.

Continuing, the following provides an explanation of an example of braking assist control processing in this embodiment by following the flow charts of FIGS. 6 and 7 and occasionally referring to FIG. 8.

As shown in FIG. 6, the musculoskeletal status information acquisition unit 102a acquires input information in the form of current vehicle driver status, various types of constraints and peripheral environment monitoring information (Step SD-1). More specifically, the musculoskeletal status information acquisition unit 102a acquires the joint positions of the driver and driver inter-joint link lengths from driver image information captured with the camera 210. In addition, the musculoskeletal status information acquisition unit 102a acquires constraints in the form of joint range of motion data, musculoskeletal data and the like stored in the physical musculoskeletal information database 106a. In addition, the musculoskeletal status information acquisition unit 102a may also acquire a portion of various input information such as information indicating movement of the driver (load) detected with the contact sensor 220 (such as a seat pressure sensor) or information indicating the distance between the driver and the operating member 500 (such as the brake pedal 520) detected with the non-contact sensor 230. In addition, the control unit 102 may acquire a portion of various types of input information in the form of peripheral environment information of the host vehicle (such as current position of the host vehicle or distance from a forward vehicle) detected with the position detection unit 300 and the peripheral information detection unit 400. Furthermore, the processing of this Step SD-1 corresponds to the processing of Step SA-1 shown in FIG. 1.

The operation prediction unit 102b then derives the movement or operation having the highest probability of being carried out next from the current status of the driver or peripheral environment information (such as inter-vehicle distance) based on the input information acquired in Step SD-1 (Steps SD-2 and SD-3). More specifically, in Step SD-2, the operation prediction unit 102b calculates, for example, the movable directions of the feet and the probability of movement. The operation prediction unit 102b then estimates operation in the forward and backward directions of an accelerator pedal (not shown) or the brake pedal 520 and the like. Furthermore, the processing of Steps SD-2 and SD-3 corresponds to Step SA-2 in FIG. 1.

The following provides an explanation of the processing of the operation prediction unit 102b in Steps SD-1 and SD-2 with reference to FIGS. 7 and 8.

As shown in FIG. 7, the operation prediction unit 102b monitors the inclination of the vertical axis of the torso as shown in FIG. 8 or a change in pressure distribution (load) of the driver's seat based on input information acquired in Step SD-1 (Step SE-1).

The operation prediction unit 102b then applies constraints of each of the inter-joint links of the driver's lower body shown in FIG. 8 (Step SE-2).

Next, the operation prediction unit 102b applies range of motion conditions for each joint of the driver and muscle force balance (flexure, extension) conditions as shown in FIG. 8 (Step SE-3). More specifically, the operation prediction unit 102b applies range of motion and muscle force balance of the knee and hip joints shown in FIG. 8 (musculoskeletal constraints).

The operation prediction unit 102b then integrates information from other peripheral environment monitoring sensors (such as the position detection unit 300 and the peripheral information detection unit 400) acquired by the processing of the control unit 102 (Step SE-4). For example, the operation prediction unit 102b may determine the possibility of depressing the brake pedal 520 to be high in the case of a short inter-vehicle distance by adding and integrating peripheral environment information and the like.

Next, the operation prediction unit 102b estimates the movement of the driver and the amount of operation of the operating member 500 such as the brake pedal 520 from the current status (Step SE-5). More specifically, the operation prediction unit 102b estimates whether or not there is the possibility of operation of the operating member 500 such as the brake pedal 520.

Returning to FIG. 6, the mechanism control unit 102c derives the need for braking assist and amount of assist based on the estimation results obtained in Steps SD-2 and SD-3 (Steps SD-4 and SD-5). More specifically, the operation prediction unit 102b determines scheduled operation of braking assist in Step SD-4, and controls pre-pressurization of braking assist by pressurizing the insensitive range (amount of play) of oil pressure of the braking mechanism 620 in advance so as to diminish a sense of incongruence and restriction divergence that can cause a problem in assist control in Step SD-5. Furthermore, the processing of Steps SD-4 and SD-5 correspond to Step SA-3 in FIG. 1.

The mechanism control unit 102c then provides assist (braking amount pressurization) in coordination with the timing at which operation is predicted to be initiated or the timing of an actual operation by the driver (Steps SD-6 and SD-7). More specifically, the operation prediction unit 102b either controls braking assist prior to the detection of an actual operation of the brake pedal 520 by the driver in Step SD-6 or controls braking assist in coordination with that timing in Step SD-7. Furthermore, the processing of Steps SD-6 and SD-7 corresponds to Step SA-3 in FIG. 1.

In this manner, a safer and more comfortable vehicle motion system (braking assist) that reduces a sense of incongruence of the driver and inhibits restriction divergence is constructed by the braking assist control processing described above. This concludes the explanation of braking assist control processing.

This concludes the explanation of the processing of the operation support apparatus 100.

### Other Embodiments

Although the preceding description has provided an explanation of one embodiment of the invention, the invention may also be carried out in the form of various other different embodiments within the scope of the technical idea described in the claims.

For example, the operation support apparatus 100 of the invention may also be applied to an activating mechanism used in a factory as described above (such as a robot arm) or to control of various devices other than a vehicle.

In addition, all or a portion of the processing explained in the previous embodiment as being carried out automatically can also be carried out manually. Alternatively, all or a portion of the processing explained as being carried out manually can be carried out automatically using conventional methods.

In addition, processing procedures, control procedures, specific names, information including parameters such as processing registration data or search conditions and the like, screen examples and database configuration can be arbitrarily modified unless specifically stated otherwise.

In addition, each of the constituent features relating to the operation support apparatus 100 shown in the drawings indicate functional concepts, and are not necessarily required to be physically composed as shown in the drawings.

For example, all or any arbitrary portion of each of the processing functions provided by each device of the operation support apparatus 100, and particularly those processing functions carried out with the control unit 102, may be realized by a central processing unit (CPU) and program determined and executed with that CPU, or may be realized with hardware in the form of wired logic. Furthermore, the program is recorded onto a recording medium to be described later, and mechanically read into the operation support apparatus 100 as necessary. Namely, the storage unit 106 such as read-only memory (ROM) or hard disk (HD) imparts commands to the CPU by functioning as an OS in coordination therewith, and a computer program for carrying out each processing is recorded therein. This computer program is executed by loading into random access memory (RAM) to compose the control unit 102 in coordination with the CPU.

In addition, this computer program may also be stored in an application program server such as a car navigation center connected to the operation support apparatus 100 through an arbitrary network, and all or a portion thereof can also be downloaded as necessary.

In addition, the program as claimed in the invention can also be contained on a computer-readable recording medium. Here, this “recording medium” includes a “portable physical medium” such as a flexible disc, magneto-optical disc (MO), ROM, erasable programmable read only memory (EPROM), electrically erasable programmable read only memory (EEPROM), compact disc-read only (CD-ROM), or Digital Versatile Disc, (DVD), as well as a “communication medium” for retaining programs for short periods of time in the manner of communication lines and carrier waves in the case of transmitting a program via a network as exemplified by a local area network (LAN), wide area network (WAN) or the Internet.

In addition, a “program” refers to a data processing method written in an arbitrary language or script, and be in any form such as source code or binary code. Furthermore, a “program” is not limited to that composed unitarily, but rather may be composed by being dispersed among a plurality of modules or libraries, and includes that which achieves the function thereof by operating in coordination with a separate program as exemplified by an OS. Furthermore, conventional configurations and procedures can be used for specific configurations, reading procedures or installation procedures following reading and the like for reading recording media in each device indicated in the embodiments.

The various databases housed in the storage unit 106 (such as the physical musculoskeletal information database 106a) are memory devices such as RAM or ROM, stationary disc drives such as a hard disc drive, or storage devices such as a flexible disc or optical disc, and contain various types of programs, tables, files and databases used in various processing, information required for predicting operations by a driver (such as physical joint constraints (range of motion) or muscle antagonistic balance (such as the strength of flexure and extension for each joint)), information required for travel by the vehicle (such as maps, straight sections of road, curves, on and off ramps or expressways) and the like.

Moreover, the specific forms of device decentralization and integration are not limited to those shown in the drawings, but rather all or a portion thereof can be composed by functionally or physically decentralizing or integrating in arbitrary units corresponding to various types of additions and the like or corresponding to functional load.

As has been described in detail above, since an operation support apparatus and operation support method can be provided that are capable of accurately monitoring and estimating perceptions and operations of an operator during activating mechanism control (including vehicle motion control), and enable operations by activating mechanisms (including vehicle motion) to be carried out safer and more comfortably based on the results of estimation, this apparatus and method are extremely useful in various fields, such as information processing fields and information processing devices, which support operation of activating mechanisms in vehicle motion control and various other industrial fields.

1-24. (canceled)

25. An operation support apparatus, comprising:
a musculoskeletal status detection unit that detects a musculoskeletal status of an operator;
an operating member that is operated by the operator;
an activating mechanism that operates in response to an operation of the operating member; and
a control unit, which includes a musculoskeletal status information acquisition unit that acquires a musculoskeletal status information of the operator by controlling the musculoskeletal status detection unit, an operation prediction unit that predicts whether the operation of the operating member is operated by the operator based on the musculoskeletal status information acquired by the musculoskeletal status information acquisition unit, and a mechanism control unit that either executes a preprocessing operation of an actual operation of the activating mechanism prior to the operation of the operating member, or initiates the actual operation, in a case where the operation of the operating member has been predicted to be operated by the operation prediction unit.

26. The operation support apparatus according to claim 25, wherein
the operator is a driver of a vehicle, and
the musculoskeletal status detection unit, the operating member, the activating mechanism and the control unit are installed in the vehicle.

27. The operation support apparatus according to claim 26, wherein
the musculoskeletal status information acquisition unit acquires the musculoskeletal status information of an extremity of the driver in contact with the operating member.

28. The operation support apparatus according to claim 26, wherein
the musculoskeletal status information acquisition unit acquires the musculoskeletal status information of a portion of the body below a head of the driver.

29. The operation support apparatus according to claim 26, wherein
the operating member is a member to be used by the driver for controlling the activating mechanism that controls vehicle motion, and
the mechanism control unit executes an auxiliary control on the vehicle motion occurring due to the operation of the operating member.

30. The operation support apparatus according to claim 27, further comprising
a storage unit,
wherein the storage unit includes a physical musculoskeletal information storage unit that stores a physical musculoskeletal information at least including a motion range constraint condition of an extremity or a portion of the body below a head determined on the basis of a range of motion of joints of the driver, and
the operation prediction unit refers to the motion range constraint condition stored in the physical musculoskeletal information storage unit and predicts whether the operating member is operated by the driver based on the musculoskeletal status information acquired by the musculoskeletal status information acquisition unit.

31. The operation support apparatus according to claim 27, wherein
the operating member includes a steering wheel,
the activating mechanism includes a steering mechanism, and
the mechanism control unit executes torque-assist control for the steering mechanism that operates in response to the operation of the steering wheel by the driver.

32. The operation support apparatus according to claim 31, wherein
a motion range constraint condition includes an elbow joint motion range constraint condition defined based on a motion range of elbows of the driver, and
the operation prediction unit predicts a direction in which the steering wheel is operated by the driver, based on the musculoskeletal status information acquired by the musculoskeletal status information acquisition unit and the elbow joint motion range constraint condition stored in the physical musculoskeletal information storage unit.

33. The operation support apparatus according to claim 31, wherein
in a case where the direction of the operation of the steering wheel is predicted by the operation prediction unit, the mechanism control unit executes play-reduction processing of gears of the steering mechanism so as to operate in the predicted direction of the operation prior to the steering wheel being operated, or imparts torque to the steering mechanism so as to operate in the predicted direction either at timing of the operation of the steering wheel predicted by the operation prediction unit or at timing at which the steering wheel is operated by the driver.

34. The operation support apparatus according to claim 27, wherein
the operating member includes a brake pedal,
the activating mechanism includes a braking mechanism, and
the mechanism control unit executes braking assist control for the braking mechanism that operates in response to the operation of the brake pedal by the driver.

35. The operation support apparatus according to claim 34, wherein
a motion range constraint condition includes a leg joint motion range constraint condition defined based on a range of motion of at least one of either a knee joint or a hip joint of the driver, and
the operation prediction unit predicts whether the brake pedal is operated by the driver based on the musculoskeletal status information acquired by the musculoskeletal status information acquisition unit and the leg joint motion range constraint condition stored in the physical musculoskeletal information storage unit.

36. The operation support apparatus according to claim 34, wherein
in a case where the operation prediction unit predicts that the brake pedal is operated by the driver
the mechanism control unit executes oil pressurization processing so as to eliminate an insensitive range of the braking mechanism prior to the brake pedal being operated, or executes the oil pressurization processing on the braking mechanism so that the braking mechanism operates either at timing at which the brake pedal has been predicted to be operated by the operation prediction unit or at timing at which the brake pedal is operated by the driver.

37. An operation support apparatus according to claim 28, further comprising
a storage unit,
wherein the storage unit includes a physical musculoskeletal information storage unit that stores a physical musculoskeletal information at least including a motion range constraint condition of an extremity or a portion of the body below a head determined on the basis of a range of motion of joints of the driver, and
the operation prediction unit refers to the motion range constraint condition stored in the physical musculoskeletal information storage unit and predicts whether the operating member is operated by the driver based on the musculoskeletal status information acquired by the musculoskeletal status information acquisition unit.

38. The operation support apparatus according to claim 28, wherein
the operating member includes a steering wheel,
the activating mechanism includes a steering mechanism, and
the mechanism control unit executes torque-assist control for the steering mechanism that operates in response to the operation of the steering wheel by the driver.

39. The operation support apparatus according to claim 38, wherein
a motion range constraint condition includes an elbow joint motion range constraint condition defined based on a motion range of elbows of the driver, and
the operation prediction unit predicts a direction in which the steering wheel is operated by the driver, based on the musculoskeletal status information acquired by the musculoskeletal status information acquisition unit and the elbow joint motion range constraint condition stored in the physical musculoskeletal information storage unit.

40. The operation support apparatus according to claim 38, wherein
in a case where the direction of the operation of the steering wheel is predicted by the operation prediction unit, the mechanism control unit executes play-reduction processing of gears of the steering mechanism so as to operate in the predicted direction of the operation prior to the steering wheel being operated, or imparts torque to the steering mechanism so as to operate in the predicted direction either at timing of the operation of the steering wheel predicted by the operation prediction unit or at timing at which the steering wheel is operated by the driver.

41. The operation support apparatus according to claim 28, wherein
the operating member includes a brake pedal,
the activating mechanism includes a braking mechanism, and
the mechanism control unit executes braking assist control for the braking mechanism that operates in response to the operation of the brake pedal by the driver.

42. The operation support apparatus according to claim 41, wherein
a motion range constraint condition includes a leg joint motion range constraint condition defined based on a range of motion of at least one of either a knee joint or a hip joint of the driver, and
the operation prediction unit predicts whether the brake pedal is operated by the driver based on the musculoskeletal status information acquired in the musculoskeletal status information acquisition unit and the leg joint motion range constraint condition stored in the physical musculoskeletal information storage unit.

43. The operation support apparatus according to claim 41, wherein
in a case where the operation prediction unit predicts whether that the brake pedal is operated by the driver,
the mechanism control unit executes oil pressurization processing so as to eliminate an insensitive range of the braking mechanism prior to the brake pedal being operated, or executes the oil pressurization processing on the braking mechanism so that the braking mechanism operates either at timing at which the brake pedal has been predicted to be operated by the operation prediction unit or at timing at which the brake pedal is operated by the driver.

44. An operation support method, comprising:
a musculoskeletal status information acquisition process for acquiring a musculoskeletal status information relating to a musculoskeletal status of an operator;
an operation prediction process for predicting whether an operating member is operated by the operator based on the musculoskeletal status information acquired in the musculoskeletal status information acquisition process; and
a mechanism control process for, in a case where an operation of the operating member is predicted in the operation prediction process, either executing a preprocessing operation of an actual operation of an activating mechanism that operates in response to the operation of the operating member prior to the operation of the operating member, or initiating the actual operation of the activating mechanism.

45. The operation support method according to claim 44, wherein
the operator is a driver of a vehicle, and
the musculoskeletal status information acquisition process, the operation prediction process and the mechanism control process are executed in the vehicle.

46. The operation support method according to claim 45, wherein
the musculoskeletal status information of an extremity of the driver in contact with the operating member is acquired in the musculoskeletal status information acquisition process.

47. The operation support method according to claim 45, wherein
the musculoskeletal status information of a portion of the body below a head of the driver is acquired in the musculoskeletal status information acquisition process.

48. The operation support method according to claim 45, wherein
in the mechanism control process, an auxiliary control is executed for the activating mechanism that controls vehicle motion in response to the operation of the operating member.

49. The operation support method according to claim 46, wherein
a motion range constraint condition of an extremity or a portion of the body below a head of the driver defined based on a range of motion of joints of the driver are referred to in the operation prediction process, and
whether the operating member is operated by the driver is predicted based on the musculoskeletal status information acquired in the musculoskeletal status information acquisition process.

50. The operation support method according to claim 46, wherein
the operating member includes a steering wheel,
the activating mechanism includes a steering mechanism, and
torque assist control on the steering mechanism that operates in response to the operation of the steering wheel by the driver is executed in the mechanism control process.

51. The operation support method according to claim 50, wherein
a motion range constraint condition includes an elbow joint motion range constraint condition defined based on the motion range of elbow joints of the driver, and
a direction in which the steering wheel is operated by the driver is predicted in the operation prediction process based on the musculoskeletal status information acquired in the musculoskeletal status information acquisition process and the elbow joint motion range constraint condition.

52. The operation support method according to claim 50, wherein
in the case where a direction of the operation of the steering wheel is predicted in the operation prediction process, either play-reduction processing of gears of the steering mechanism is executed in the mechanism control process so as to operate in the predicted direction of the operation prior to the steering wheel being operated, or torque is imparted to the steering mechanism so as to operate in the predicted direction of the operation at timing of the operation of the steering wheel predicted in the operation prediction process or at timing at which the steering wheel is operated by the driver.

53. The operation support method according to claim 46, wherein
the operating member includes a brake pedal,
the activating mechanism includes a braking mechanism, and
braking assist control is executed on the braking mechanism that operates in response to the operation of the brake pedal by the driver in the mechanism control process.

54. The operation support method according to claim 53, wherein
a motion range constraint condition includes a leg joint motion range constraint condition defined based on a range of motion of at least one of a knee joint and a hip joint of the driver, and
whether the brake pedal is operated by the driver is predicted in the operation prediction process based on the musculoskeletal status information acquired in the musculoskeletal status information acquisition process and the leg joint motion range constraint conditions.

55. The operation support method according to claim 53, wherein
in a case where the operation of the brake pedal is predicted in the operation prediction process, either oil pressurization processing is executed in the mechanism control process so as to eliminate an insensitive range of the braking mechanism prior to the brake pedal being operated, or the oil pressurization processing is executed on the braking mechanism so that the braking mechanism operates at timing at which the brake pedal is predicted to be operated in the operation prediction process or at timing at which the brake pedal is operated by the driver.

56. The operation support method according to claim 47, wherein
a motion range constraint of an extremity or a portion of the body below a head of the driver defined based on a range of motion of joints of the driver are referred to in the operation prediction process, and
whether the operating member is operated by the driver is predicted based on the musculoskeletal status information acquired in the musculoskeletal status information acquisition process.

57. The operation support method according to claim 47, wherein
the operating member includes a steering wheel,
the activating mechanism includes a steering mechanism, and
torque assist control on the steering mechanism that operates in response to the operation of the steering wheel by the driver is executed in the mechanism control process.

58. The operation support method according to claim 57, wherein
a motion range constraint condition includes an elbow joint motion range constraint condition defined based on the motion range of elbow joints of the driver, and
a direction in which the steering wheel is operated by the driver is predicted in the operation prediction process based on the musculoskeletal status information acquired in the musculoskeletal status information acquisition process and the elbow joint motion range constraint condition.

59. The operation support method according to claim 57, wherein
in the case where a direction of the operation of the steering wheel is predicted in the operation prediction process, either play-reduction processing of gears of the steering mechanism is executed in the mechanism control process so as to operate in the predicted direction of the operation prior to the steering wheel being operated, or torque is imparted to the steering mechanism so as to operate in the predicted direction of the operation at timing of the operation of the steering wheel predicted in the operation prediction process or at timing at which the steering wheel is operated by the driver.

60. The operation support method according to claim 47, wherein
the operating member includes a brake pedal,
the activating mechanism includes a braking mechanism, and
braking assist control is executed on the braking mechanism that operates in response to the operation of the brake pedal by the driver in the mechanism control process.

61. The operation support method according to claim 60, wherein
a motion range constraint condition includes a leg joint motion range constraint condition defined based on a range of motion of at least one of either a knee joint or a hip joint of the driver, and
whether the brake pedal is operated by the driver is predicted in the operation prediction process based on the musculoskeletal status information acquired in the musculoskeletal status information acquisition process and the leg joint motion range constraint conditions.

62. The operation support method according to claim 60, wherein
in a case where the operation of the brake pedal is predicted in the operation prediction process, either oil pressurization processing is executed in the mechanism control process so as to eliminate an insensitive range of the braking mechanism prior to the brake pedal being operated, or the oil pressurization processing is executed on the braking mechanism so that the braking operates at timing at which the brake pedal is predicted to be operated in the operation prediction process or at timing at which the brake pedal is operated by the driver.
